(19) United States
(12) Patent Application Publication
(10) Pub. No.: US 2008/0040760 A1
(43) Pub. Date: Feb. 14, 2008

(54) APPARATUS AND METHOD FOR DISPLAYING FILE DOWNLOAD INFORMATION IN DIGITAL VIDEO BROADCASTING TERMINAL

(75) Inventors: Jeong-Sik Cho, Suwon-si (KR); Young-Jip Kim, Suwon-si (KR); Byoung-Dai Lee, Seongnam-si (KR); Jun-Young Choe, Suwon-si (KR); Tae-Soo Lee, Seoul (KR); Kyung-Shin Lee, Yongin-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONIC CO., LTD., Suwon-si (KR)

(21) Appl. No.: 11/835,969

(22) Filed: Aug. 8, 2007

(30) Foreign Application Priority Data
Aug. 8, 2006 (KR) 74759-2006

(51) Int. Cl. H04N 7/173

(52) U.S. Cl. 725/87

(57) ABSTRACT

Provided are an apparatus and a method for displaying file download information in a Digital Video Broadcasting (DVB) terminal. The method includes receiving an Electronic Service Guide (ESG) data stream containing information regarding downloadable files, analyzing the downloadable file information in the ESG data stream, storing the downloadable file information in the memory module, and if a file download service is selected by a user, displaying the downloadable file information on the display unit, if downloading of at least one file is selected, examining download-related information using the stored file information corresponding to each file when the selected files are downloaded, and creating a download file list containing each file name and the download-related information examined corresponding to each file and displaying the download file list on a screen.

### PRIORITY

This application claims priority under 35 U.S.C. § 119(a) to a Korean Patent Application filed in the Korean Intellectual Property Office on August 8, 2006 and assigned Serial No. 2006-74759, the contents of which are incorporated herein by reference.

### BACKGROUND OF THE INVENTION

1. Field of the Invention

The present invention relates generally to an apparatus and a method for displaying file download information in a Digital Video Broadcasting (DVB) terminal. More particularly, the present invention relates to an apparatus and method for displaying download information of each file when a plurality of files are downloaded.

2. Description of the Related Art

In general, digital broadcasting is for transmitting a broadcast signal, which may be transmitted in an analog method or in a digital method, in order to provide high image quality, high sound quality, and various services to users. There are various types of digital broadcasting. For example, there is Digital Video Broadcasting-Terrestrial (DVB-T), Digital Audio Broadcasting (DAB), Digital Multimedia Broadcasting (DMB), Media Forward Link Only (MediaFLO™), and DVB-Handheld (DVB-H).

DVB-H is a technology standard established to provide terrestrial digital broadcasting to moving terminals with good reception, and can implement digital mobile multimedia broadcasting for providing a broadcast program or high-image-quality content and high-sound-quality content at any time or place, even while driving or walking.

Unlike other digital broadcasting schemes, a DVB-H scheme transmits the most important information needed for a broadcast service by inserting the important information into an Electronic Service Guide (ESG). DVB-H uses the File deLivery over Unidirectional Transport (FLUTE) protocol as the Content Delivery Protocol (CDP). The FLUTE protocol is a protocol for transmitting text, audio, video, and image files. In the DVB-H of an initial stage, which has been being implemented, the FLUTE protocol is used to download files needed for ESG construction and ESG update.

Most recent portable terminals use a single network, such as a Code Division Multiple Access (CDMA) network or a Global System for Mobile Communication (GSM) network. A file downloading service provided by such a portable terminal using a single network allows a user to access, i.e., download, one file at a time. That is, when a user wants to download desired files by accessing a network using a portable terminal, the user can download only one file at a time. Furthermore, according to a service pattern, a phone call service or any other service cannot be used while downloading. Thus, when a file is downloaded, a user interface that is distinguished from others does not have to be provided, and only a downloading state of a currently selected file is displayed on a screen as illustrated in FIG. 1.

According to existing techniques, since only one file can be downloaded at a time in the file downloading service using a portable terminal as described above, a supported file download user interface provides only a downloading state of a single file to a user.

As described above, a file download user interface of a conventional portable terminal provides only a downloading state of a single file. Meanwhile, since a DVB-H receive terminal using the FLUTE protocol can use multiple sessions and multiple channels, a plurality of files may be downloaded. However, since only a downloading state of a single file is provided in even the DVB-H receive terminal, whenever a plurality of files is downloaded, a user cannot know the downloading state of the plurality of files.

### SUMMARY OF THE INVENTION

An aspect of the present invention is to substantially solve at least the above problems and/or disadvantages, and to provide the advantages below. Accordingly, an aspect of the present invention is to provide an apparatus and method for displaying file download information in order to provide a file download user interface.

Another aspect of the present invention is to provide an apparatus and method for displaying file download information, whereby when a DVB-H receive terminal downloads a plurality of files, the downloading state information of the plurality of files can be displayed on a screen of the DVB-H receive terminal.

According to one aspect of the present invention, there is provided an apparatus for displaying file download information in a Digital Video Broadcasting (DVB) terminal, which includes a Radio Frequency (RF) module for receiving an Electronic Service Guide (ESG) data stream containing information regarding downloadable files; a memory module for storing the downloadable file information; a display unit for displaying input data; and a digital broadcast processing unit for analyzing the downloadable file information in the ESG data stream, storing the downloadable file information in the memory module, displaying the downloadable file information on the display unit if a file download service is selected by a user, and if downloading of at least one file is selected, examining download-related information using the stored file information corresponding to each file when the selected files are downloaded, creating a download file list containing each file name and the download-related information examined corresponding to each file, and outputting the download file list to the display unit.

According to another aspect of the present invention, there is provided a method of displaying file download information in a Digital Video Broadcasting (DVB) terminal, which includes receiving an Electronic Service Guide (ESG) data stream containing information regarding downloadable files; analyzing the downloadable file information in the ESG data stream, storing the downloadable file information in the memory module, and if a file download service is selected by a user, displaying the downloadable file information on the display unit; if downloading of at least one file is selected, examining download-related information using stored file information corresponding to each file when the selected files are downloaded; and creating a download file list containing each file name and the download-related information examined corresponding to each file and displaying the download file list on a screen.

### BRIEF DESCRIPTION OF THE DRAWINGS

The above and other objects, features and advantages of the present invention will become more apparent from the following detailed description when taken in conjunction with the accompanying drawing, in which:

FIG. 1 illustrates a screen displaying file download information in a conventional terminal;

FIG. 2 is a block diagram of a Digital Video Broadcasting (DVB) terminal according to an exemplary embodiment of the present invention;

FIG. 3 is a block diagram of a file download processing unit for processing the display of file download information according to an exemplary embodiment of the present invention;

FIG. 4 is an Asynchronous Layered Coding (ALC) packet structure defined in the standard;

FIG. 5 is a flowchart of a process of displaying file download information according to an exemplary embodiment of the present invention;

FIGS. 6A and 6B illustrate screens for reserving file download according to an exemplary embodiment of the present invention; and

FIGS. 7A and 7B illustrate screens displaying file download information of a plurality of files when the plurality of files is downloaded according to an exemplary embodiment of the present invention.

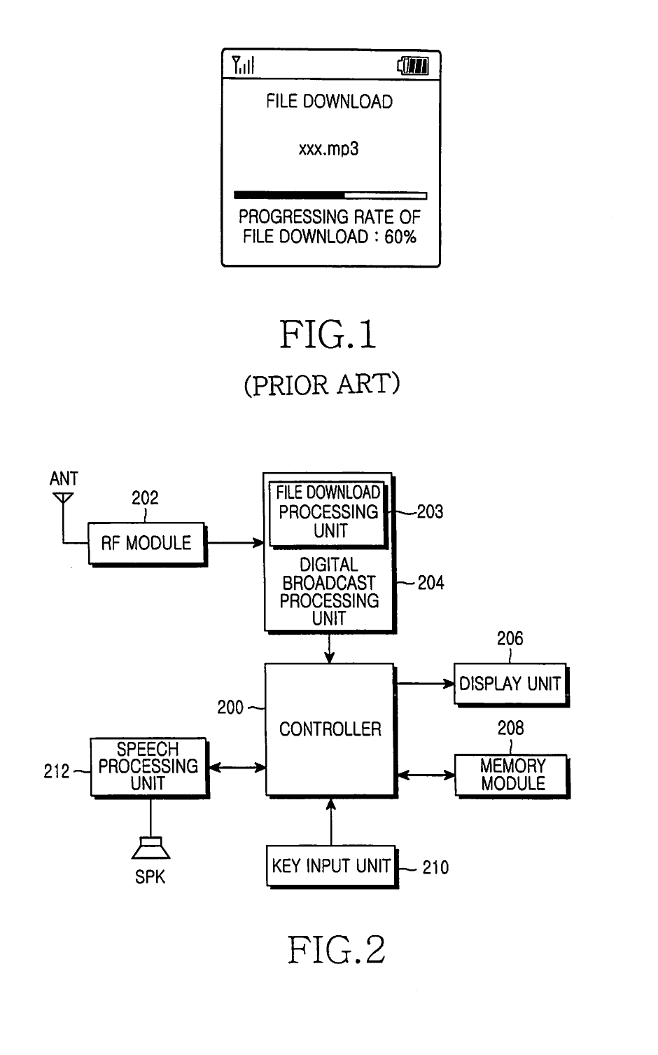

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

Since a Digital Video Broadcasting-Handheld (DVB-H) receive terminal using the File deLivery over Unidirectional Transport (FLUTE) protocol can download a plurality of files at one same time by means of multiple sessions and multiple channels via a broadcasting network, the present invention suggests a file download user interface suitable for a characteristic of the DVB-H receive terminal.

In the present invention, DVB-H providing a plurality of sessions via a single broadcasting network using time-slicing technology provides the concept of a plurality of channels in a single session. Here, sessions are identified by a source Internet Protocol (IP) address and a Transport Session Identifier (TSI), and channels in a session are identified by a destination IP address and a port number.

Basic file download in DVB-H will now be described.

In DVB-H, a session is comprised of a plurality of channels. All files provided by the session can be downloaded through a fundamental channel of the plurality of channels. In addition, in channels excluding the fundamental channel, a file download speed in the session can be increased by providing a download service of specific files among files, which can be downloaded in the fundamental channel for each channel. Thus, a DVB-H receive terminal can simultaneously download a plurality of files through a plurality of channels by accessing a plurality of sessions at the same time.

The FLUTE protocol in DVB-H provides various information regarding downloadable files. The basic concept of the FLUTE protocol is an expanded concept of Asynchronous Layered Coding/Layered Coding Transport (ALC/LCT). A basic transport packet using the FLUTE protocol is transmitted as an ALC packet, and information on a transmitted file is provided by a File Description Table (FDT) instance file. The FDT instance file for providing information on a transmitted file contains information illustrated in Table 1.

TABLE 1

| | |
|---|---|
| 1. | Transport Object ID (TOI) |
| 2. | Forward Error Correction (FEC) object transmission information |
| 3. | Encoding ID & FEC instance ID |
| 4. | Size of transport object |
| 5. | Aggregate rate of sending packet to all channels |
| 6. | Name, ID, location of file, e.g. Uniform Resource Identifier (URI) |
| 7. | Multipurpose Internet Mail Extensions (MIME) type |
| 8. | Size of file |
| 9. | Encoding of file |
| 10. | Message digest of file |

The present invention provides the file download user interface described hereinafter using the information illustrated in Table 1 and characteristics of the Content Delivery Protocol (CDP) of DVB-H.

A configuration of a DVB-H receive terminal and operations of components of the DVB-H receive terminal according to an exemplary embodiment of the present invention will now be described with reference to FIG. 2.

A Radio Frequency (RF) module 202 receives an RF signal of an Electronic Service Guide (ESG) data stream and a data stream corresponding to a digital service selected by a user in a digital broadcasting transport stream broadcasted from a digital broadcast device. The RF module 202 includes an RF receiver (not shown) for low noise amplifying a received RF signal and downstream converting a frequency of the RF signal.

A digital broadcast processing unit 204 receives an RF signal from the RF module 202, demodulates the RF signal to digital data of a baseband signal, and outputs the digital data to a controller 200. In particular, when a DVB system according to an exemplary embodiment of the present invention is implemented in a DVB-H broadcasting method, the digital broadcast processing unit 204 may be a DVB-H demodulator for deriving digital broadcast data by demodulating the RF signal received from the RF module 202 in an Orthogonal Frequency Division Multiplexing (OFDM) method. The digital broadcast processing unit 204 includes a file download processing unit 203 for analyzing information regarding a plurality of downloading files and displaying download information of each downloaded file on a display unit 206, according to an exemplary embodiment of the present invention.

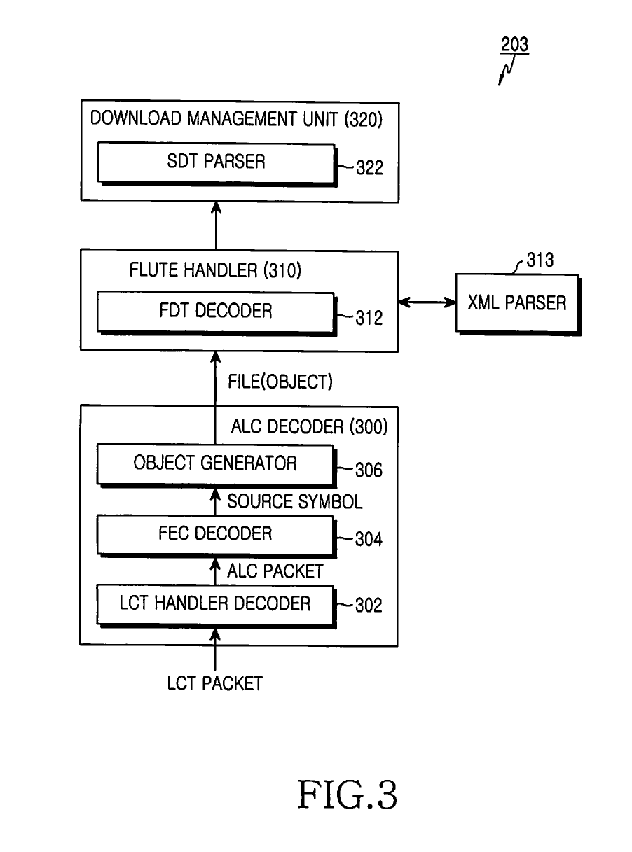

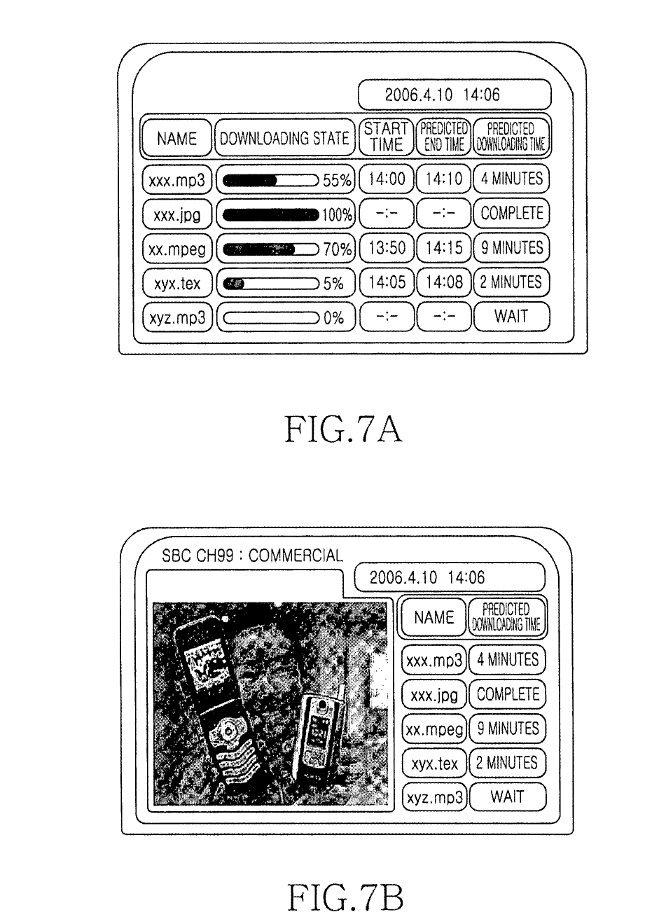

A configuration and operation of the file download processing unit 203 will now be described with reference to FIG. 3. The file download processing unit 203 includes an ALC decoder 300, a FLUTE handler 310, a download management unit 320, and an eXtensible Markup Language (XML) parser 313. When the ALC decoder 300 receives an LCT packet, which is an FDT instance file for providing information on files, the ALC decoder 300 processes and decodes an ALC packet using an LCT handler decoder 302, an FEC decoder 304, and an object generator 306. The FLUTE handler 310 processes files contained in the ALC packet and analyzes the FDT instance file in associated with the XML parser 313. The download management unit 320 performs request management and session management of an application in an upper layer. The download management unit 320 of the file download processing unit 203 according to an exemplary embodiment of the present invention analyzes downloadable file information in a received ESG data stream and stores the downloadable file information in a memory module 208, and if downloading of at least one file is selected, examines download-related information using the stored file information corresponding to each file, which is stored in the memory module 208 when each selected file is downloaded, creates a download file list containing each file name and the download-related information examined corresponding to each file, and outputs the download file list to the display unit 206. The download-related information is information, such as the name of a downloaded file, a downloading state, a download start time, a predicted downloading time, and a predicted download end time, and is illustrated in FIGS. 7A and 7B. The download management unit 320 according to the present invention also performs a download reservation function, a downloading state display function, a predicted downloading time and download end time display function, and a download file list display function.

Detailed operations of the file download processing unit 203 to perform the four functions will now be described.

First, an operation of the file download processing unit 203 to perform the download reservation function will be described.

As described above, the DVB-H receive terminal can simultaneously download a plurality of files through a plurality of channels by accessing a plurality of sessions at the same time. Here, each file is transmitted through a session, wherein each session has a valid time. That is, each session has parameters of a start time and an end time, and a file access and download can be performed between the defined start time and the defined end time. Information for the file access and download is provided to the user using ESG data. Thus, in order to download a specific file, the file download service can be provided by detecting information for an access and download of the specific file from ESG data and accessing a session at the time assigned to the session. In the current embodiment, the user can make a download reservation of a specific file in a state where ESG information is displayed on a screen.

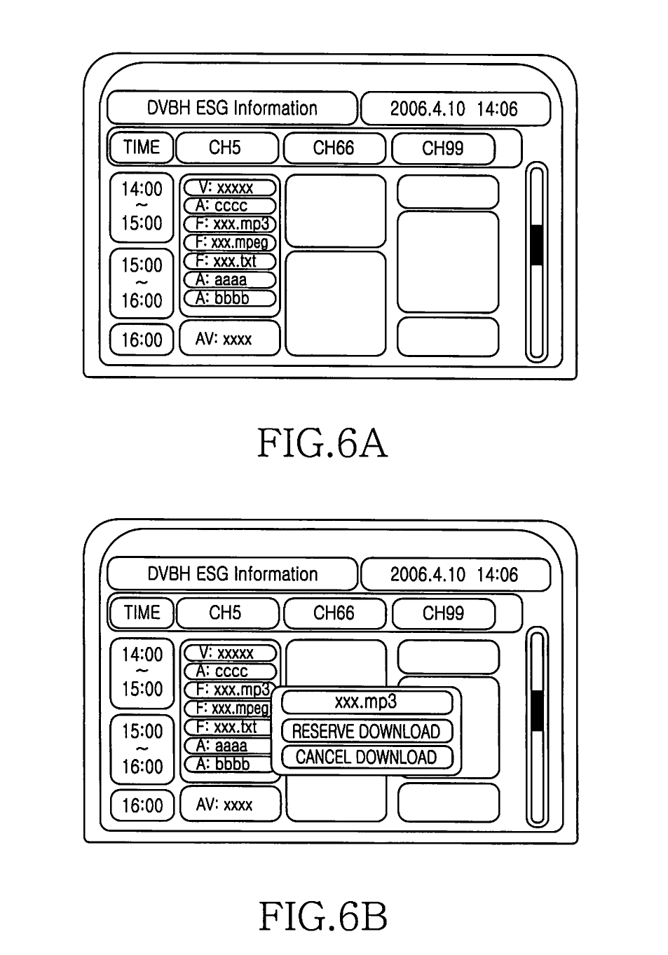

An example of displaying ESG information on a screen is illustrated in FIG. 6A. A screen for making a download reservation of a specific file, which is selected by the user on the screen of FIG. 6A, is illustrated in FIG. 6B. If the user moves a cursor onto a file to be downloaded and selects a menu key on the screen illustrated in FIG. 6A, a menu screen illustrated in FIG. 6B is displayed. If the user selects “download reservation”, file download reservation is set as described above, and the selected file is registered in the download list, as illustrated in FIG. 7A, which will be described later. If the download reservation of the specific file is set as described above, the FLUTE handler 310 of the file download processing unit 203 sets a timer for a start time of a session, which can access and download the selected file, and stores source IP and TSI information of the session, and a file name or TOI in the memory module 208. Thereafter, the controller 200 determines whether the file download time reserved by the user comes, and if the file download time comes, the controller 200 controls the download management unit 320 to access the session for downloading the selected file and request to download the selected file using the file name or TOI.

As described above, if the user makes a download reservation of a specific file, the current embodiment provides the function performed by the DVB-H receive terminal to access a session at a downloadable time and automatically download the reserved file, using source IP and TSI information of the session and a file name or TOI, which are information required to download the reserved file.

An operation of the file download processing unit 203 to perform the downloading state display function will now be described.

In the current embodiment, the DVB-H receive terminal can display a downloading state of a file on a screen when the file is downloaded. In detail, the controller 200 can detect a downloading state of a specific file using “size of transport object” transmitted by means of an FDT instance file.

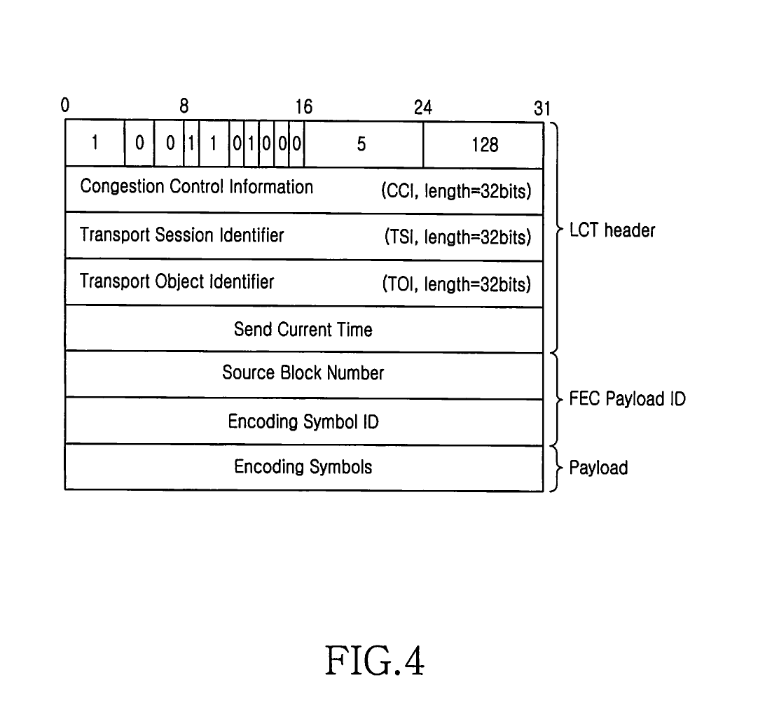

An ALC packet structure defined in the standard will now be described with reference to FIG. 4. An ALC packet is composed of an LCT header, an FEC payload ID, and a payload, wherein an LCT header is composed of Congestion Control Information (CCI), a TSI, a TOI, and a send current time. The FEC payload ID is composed of a source block number and an encoding symbol ID, and the payload is composed of encoding symbols. That is, an FDT instance file of an ALC packet type contains information regarding how many encoding symbols composes a transmitted file. Thus, before a file is downloaded, the DVB-H receive terminal can detect information on a number of encoding symbols required to compose the file. Each received packet has a source block number and an encoding symbol ID. In the FLUTE protocol, a file is composed of at least one source block, each source block composed of at least one encoding symbol. Thus, if a number of received source blocks and a number of received encoding symbols are detected, a progress rate of the file downloading can be calculated.

An operation of the file download processing unit 203 to perform the predicted downloading time and download end time display function will now be described.

For a predicted downloading time, as information regarding a transmission speed in DVB-H, many pieces of information provided based on a physical layer have been known and provided. Thus, a predicted downloading time and download end time providing service for a specific file can be easily implemented using file size information provided by means of an FDT instance file and a general transmission speed in DVB-H. However, a predicted downloading time can be calculated by setting a file download start time when a first packet of the specific file is received. In this case, since the DVB-H receive terminal does not have any information regarding when the first packet of the specific file is received based on a session access time, the file download start time can be determined by informing an upper layer of when the ALC decoder 300 receives the first packet of the specific file.

An operation of the file download processing unit 203 to perform the download file list display function will now be described.

When downloading of one or more files is requested, a fourth function allows the user to see a state of the files requested by the user at one time by displaying the downloading state and the predicted downloading time and download end time of each file, which are calculated by means of second and third functions. In addition, since a real-time video and audio transmission path is different from a file transmission path in DVB-H with the multi-session and multi-channel concept, a video/audio stream and a file related packet can be simultaneously received. Thus, the DVB-H receive terminal can be implemented to display a downloading screen of requested files by changing to a file list screen with a simple shortcut key or menu operation, even while using a video/audio service. For example, a screen displaying a downloading state information list of files of which downloading is requested is illustrated in FIG. 7A. In addition, the screen can be divided into two areas while using the video/audio service, wherein one area is used as a video/audio service screen and the other area is used to display downloading state information of the files of which downloading is requested. For example, FIG. 7B illustrates a screen divided into two areas in which a video/audio service and a download service are displayed.

As shown in FIG. 2, a speech-processing unit 212 converts a speech signal output from the controller 200 to an audible sound.

A key input unit 210 includes number keys (including the ‘*’ key and the ‘#’key) for watching digital broadcasting and function keys for various functions, and generates a key signal corresponding to a key pushed by the user and outputs the key signal to the controller 200.

The memory module 208 stores data required to control the DVB-H receive terminal. In particular, according to the current embodiment, the memory module 208 stores ESG data transmitted from a digital broadcast device.

The display unit 206 displays a current state and an operating state of the DVB-H receive terminal under the control of the controller 200, and in general, the display unit 206 can be constructed of Liquid Crystal Display (LCD) or Organic Light Emitting Diodes (OLED).

The controller 200 controls the components of the DVB-H receive terminal in order to perform a digital broadcasting service. In particular, according to the current embodiment, if download reservation of a specific file is selected by the user, the controller 200 controls the file download processing unit 203 to download the specific file at the time at which the specific file can be downloaded. When files are downloaded according to a file download service selected by the user, the controller 200 controls the file download processing unit 203 to detect downloading information of the files, e.g. a downloading state, a predicted downloading time and download end time, updates information of the files being downloaded, and controls the display unit 206 to display each file name and the detected downloading information as a download file list.

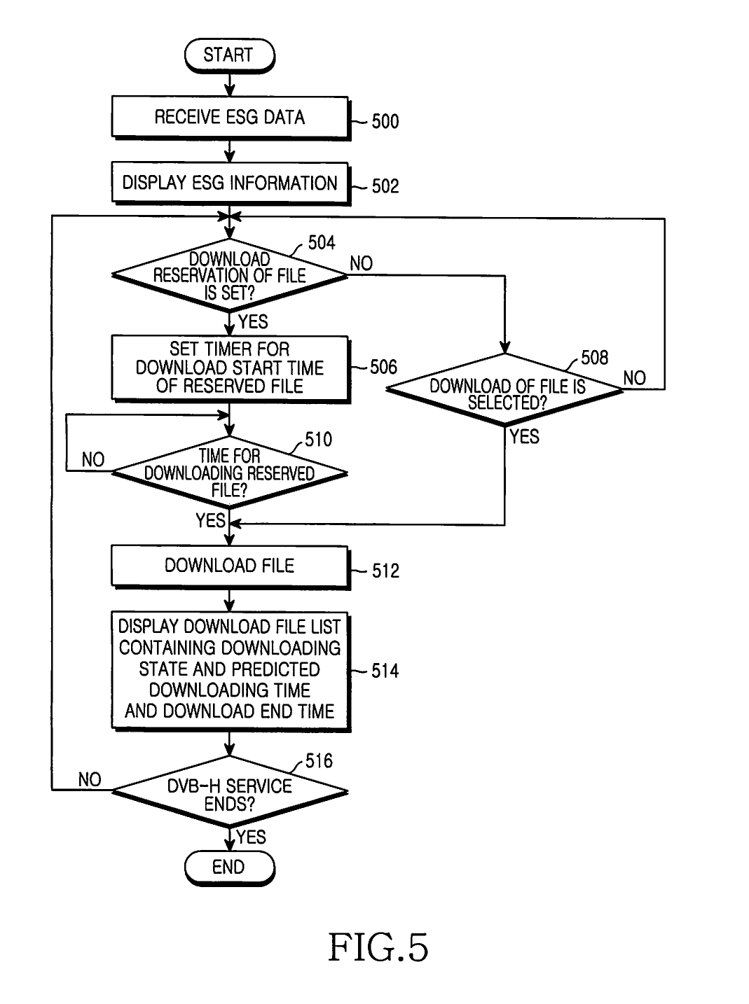

FIG. 5 is a flowchart of a process of displaying a downloading state on a screen as a list when the DVB-H receive terminal illustrated in FIGS. 2 and 3 downloads a file of which downloading is requested, according to an exemplary embodiment of the present invention.

Referring to FIG. 5, if ESG data is received in step 500, the controller 200 displays ESG information on the display unit 206 in step 502, as illustrated in FIG. 6. The controller 200 determines in step 504 whether download reservation of a specific file is requested by the user. If it is determined in step 504 that download reservation of a specific file is requested, the controller 200 sets a timer for a download start time of the reserved file in step 506. If it is determined in step 504 that download reservation of a specific file is not requested, the controller 200 determines in step 508 whether the specific file is selected. If the specific file to be downloaded is selected, the process proceeds to step 512. If not, the process proceeds to step 504. The controller 200 determines in step 510 whether the download start time of the reserved file comes. That is, the controller 200 continuously determines whether the set timer has expired, and if it is determined in step 510 that the set timer has expired, the controller 200 accesses a session for downloading the reserved file and downloads the reserved file in step 512. The controller 200 controls the file download processing unit 203 to detect a downloading state, a predicted downloading time, and a predicted download end time as illustrated in FIG. 3 and controls the display unit 206 to display a download file list containing each file name and file downloading information in step 514.

The controller determines in step 516 whether a key signal for ending a DVB-H service is input. If it is determined in step 516 that the key signal for ending the DVB-H service is input, the process ends, otherwise the process proceeds to step 504. If the key signal for ending the DVB-H service is not input in step 516 in a state where the download file list performed in step 514 is displayed as described above, the process proceeds to step 504. If the download reservation of the specific file is set, the operation of the download reservation of the specific file proceeds to step 506. In addition, if the download reservation of the specific file is not set in step 504, the process proceeds to step 508.

As described above, according to the present invention, if downloading of a plurality of files is requested in a DVB-H receive terminal, by displaying a download file list containing download-related information on a screen when the requested files are downloaded, a user can see a downloading state at a glance.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An apparatus for displaying file download information in a Digital Video Broadcasting (DVB) terminal, the apparatus comprising:
a Radio Frequency (RF) module for receiving an Electronic Service Guide (ESG) data stream containing information regarding downloadable files;
a memory module for storing the downloadable file information;
a display unit for displaying input data; and
a digital broadcast processing unit for analyzing the downloadable file information in the ESG data stream, storing the downloadable file information in the memory module, displaying the downloadable file information on the display unit if a file download service is selected by a user, and if downloading of at least one file is selected, examining download-related information using stored file information corresponding to each file when selected files are downloaded, creating a download file list containing each file name and the examined download-related information corresponding to each file, and outputting the download file list to the display unit.

2. The apparatus of claim 1, further comprising a controller for setting a timer for a start time of a session by which at least one reserved file is provided if a reservation request of the at least one file is input, and controlling the digital broadcast processing unit to download the at least one reserved file when the timer has expired.

3. The apparatus of claim 2, wherein, when the timer has expired, the digital broadcast processing unit examines download-related information using stored file information corresponding to the at least one file downloaded by the digital broadcast processing unit and outputs a download file list containing the download-related information, of the at least one file downloaded according to the reservation, to the display unit.

4. The apparatus of claim I, wherein the download-related information comprises at least one of a downloaded file name, a downloading state, a download start time, a predicted downloading time, and download end time.

5. The apparatus of claim 4, wherein the downloadable file information comprises at least one of a ‘Transport Object ID (TOI)’, a ‘Forward Error Correction (FEC) object transmission information’, an ‘encoding ID & FEC instance ID’, a ‘size of transport object’, an ‘aggregate rate of sending packet to all channels’, a ‘Name, ID, location of file, e.g. Uniform Resource Identifier (URI)’, a ‘Multipurpose Internet Mail Extensions (MIME) type’, a ‘size of file’, an ‘encoding of file’, and a ‘message digest of file’.

6. The apparatus of claim 5, wherein the digital broadcast processing unit determines the downloading state using the size of transport object.

7. The apparatus of claim 5, wherein the digital broadcast processing unit determines the download start time as a time when a first packet of a file selected for the download request by the user is received.

8. The apparatus of claim 5, wherein the digital broadcast processing unit determines the predicted downloading time and download end time using transmission speed information of general digital broadcast data and the size of file.

9. The apparatus of claim 1, wherein the DVB terminal has a broadcasting service function of a DVB-Handheld (DVB-H) method.

10. A method of displaying file download information in a Digital Video Broadcasting (DVB) terminal, the method comprising:
receiving an Electronic Service Guide (ESG) data stream containing information regarding downloadable files;
analyzing the downloadable file information in the ESG data stream, storing the downloadable file information in a memory module, and if a file download service is selected by a user, displaying the downloadable file information on a display unit;
if downloading of at least one file is selected, examining download-related information using stored file information corresponding to each file when selected files are downloaded; and creating a download file list containing each file name and the download-related information examined corresponding to each file and displaying the download file list on a screen.

11. The method of claim 10, further comprising:
if a reservation request of at least one file is input after displaying the downloadable file information, setting a timer for a start time of a session by which the at least one reserved file is provided; and
if the timer has expired, downloading the at least one reserved file.

12. The method of claim 11, further comprising:
if the timer has expired, examining download-related information using stored file information corresponding to the at least one file being downloaded; and
displaying a download file list containing the download-related information of the at least one file downloaded according to a reservation on the screen.

13. The method of claim 10, wherein the download-related information comprises at least one of a downloaded file name, a downloading state, a download start time, a predicted downloading time and download end time.

14. The method of claim 13, wherein the downloadable file information comprises at least one of a ‘Transport Object ID (TOI)’, a ‘Forward Error Correction (FEC) object transmission information’, an ‘encoding ID & FEC instance ID’, a ‘size of transport object’, an ‘aggregate rate of sending packet to all channels’, a ‘Name, ID, location of file, e.g. Uniform Resource Identifier (URI)’, a ‘Multipurpose Internet Mail Extensions (MIME) type’, a ‘size of file’, ‘encoding of file’, and a ‘message digest of file’.

15. The method of claim 14, wherein the downloading state is determined using the size of transport object.

16. The method of claim 14, wherein the download start time is determined as a time when a first packet of a file selected for a download request by the user is received.

17. The method of claim 14, wherein the predicted downloading time and download end time are determined using transmission speed information of a general digital broadcast data and the size of file.
